(19) United States
(12) Patent Application Publication
(10) Pub. No.: US 2013/0153620 A1
(43) Pub. Date: Jun. 20, 2013

(54) Staple Gun

(71) Applicant: Roger Shen, Taichung City (TW)

(72) Inventor: Roger Shen, Taichung City (TW)

(21) Appl. No.: 13/327,875

(22) Filed: Dec. 16, 2011

(51) Int. Cl. B25C 5/16

(52) U.S. Cl. 227/120

(57) ABSTRACT

A staple gun has a main body, an adjusting strip and a positioning device. The main body has a cartridge having a staple recess, a through hole and a taking opening. The through hole and the taking opening are formed through a first inner side surface of the staple recess. The taking opening is next to and communicates with a recess opening of the staple recess. The adjusting strip is slidably mounted in the staple recess and has a positioning recess aligning with the through hole when the adjusting strip is securely positioned in the staple recess. The positioning device has a protrusion mounted through the through hole and mounted in and engaging the positioning recess. With the cartridge having the taking opening, the adjusting strip is easily taken out from the staple recess.

### BACKGROUND OF THE INVENTION

1. Field of the Invention

The present invention relates to a staple gun, and more particularly to a staple gun allowing an adjusting strip to be easily taken out.

2. Description of Related Art

A conventional staple gun has a main body and an adjusting strip. The main body has a cartridge, a handle and a power device. The cartridge has a staple recess and a bracket. The staple recess is elongated and has a recess opening located at a bottom of the cartridge. The bracket is longitudinally and slidably mounted in the staple recess and is capable of closing the recess opening of the staple recess. The adjusting strip is slidably mounted in the staple recess and has a length. The length of the adjusting strip is the same as that of the staple recess. The adjusting strip can be taken out from the staple recess and slid into the staple recess again to change a position of the adjusting strip. When staples of different lengths are placed in the staple recess, the position of the adjusting strip has to be adjusted to fit the staples.

Because the length of the adjusting strip is the same as that of the staple recess, the adjusting strip has to completely come off the staple recess to be taken out. However, a distance between a bottom end of the bracket and the recess opening is substantially the same as the length of the adjusting strip when the bracket is pulled downwardly to a lowest position. Consequently, the bracket has to be detached to let the adjusting strip come off. A user has to detach the bracket every time the position of the adjusting strip has to be adjusted and this is inconvenient.

To overcome the shortcomings, the present invention tends to provide a staple gun to mitigate the aforementioned problems.

### SUMMARY OF THE INVENTION

The main objective of the invention is to provide a staple gun allowing an adjusting strip to be easily taken out.

A staple gun has a main body, an adjusting strip and a positioning device. The main body has a cartridge having a staple recess, a through hole and a taking opening. The through hole and the taking opening are formed through a first inner side surface of the staple recess. The taking opening is next to and communicates with a recess opening of the staple recess. The adjusting strip is slidably mounted in the staple recess and has a positioning recess aligning with the through hole when the adjusting strip is securely positioned in the staple recess. The positioning device has a protrusion mounted through the through hole and mounted in and engaging the positioning recess. With the cartridge having the taking opening, the adjusting strip is easily taken out from the staple recess.

Other objects, advantages and novel features of the invention will become more apparent from the following detailed description when taken in conjunction with the accompanying drawings.

### BRIEF DESCRIPTION OF THE DRAWINGS

FIG. 1 is a side view of a staple gun in accordance with the present invention;

FIG. 2 is an enlarged partial perspective view of the staple gun in FIG. 1;

FIG. 3 is an enlarged and operational perspective view of the staple gun in FIG. 2 showing the bracket is pulled downwardly;

FIG. 4 is an enlarged cross sectional view of the staple gun in FIG. 1;

FIG. 5 is an operational cross sectional view of the staple gun in FIG. 1 showing the push section of the positioning member is pushed;

FIG. 6 is an operational cross sectional side view of the staple gun in FIG. 5 showing the adjusting strip is taken out; and

FIG. 7 is an operational side view of the staple gun in FIG. 6 showing the adjusting strip is taken out.

### DETAILED DESCRIPTION OF PREFERRED EMBODIMENT

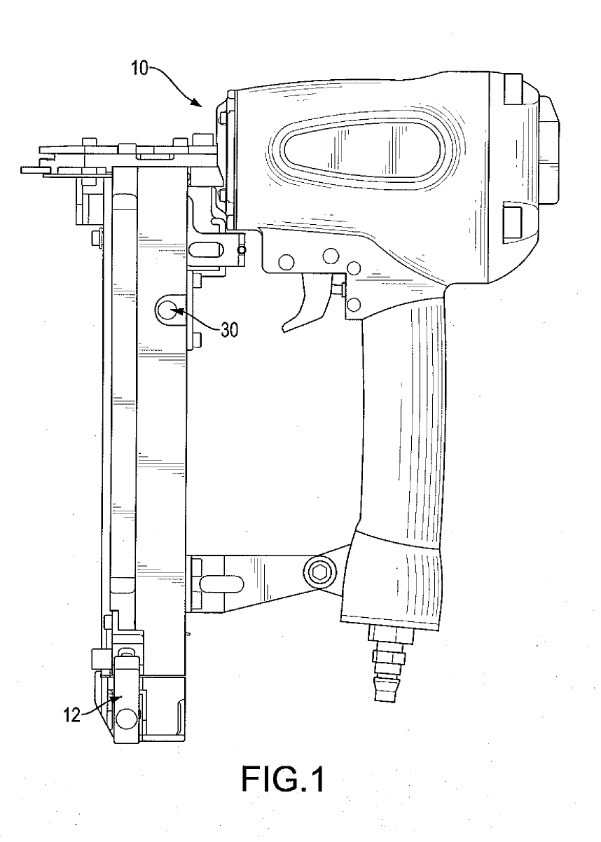

With reference to FIGS. 1, 2 and 4, a staple gun in accordance with the present invention comprises a main body, an adjusting strip 20 and a positioning device 30.

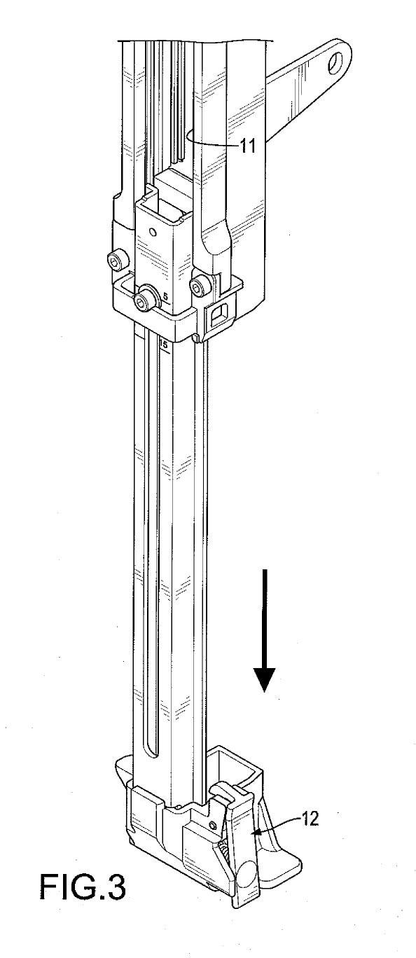

With reference to FIGS. 1, 3, 5 and 7, the main body has a cartridge 10, a handle and a power device. The cartridge 10 has a staple recess 11, a bracket 12, a through hole 13 and a taking opening 14.

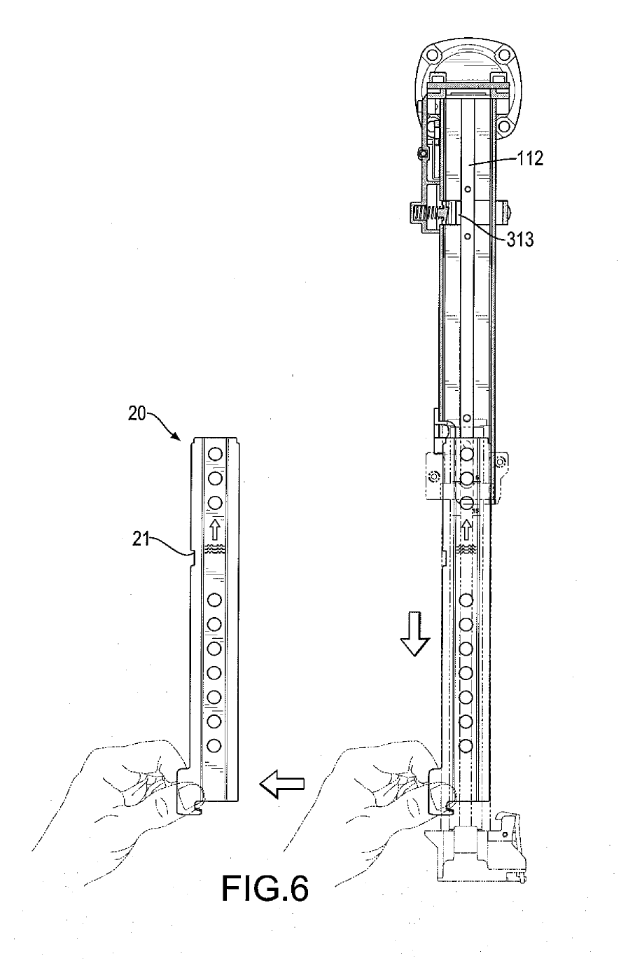

The staple recess 11 is elongated, is formed in the cartridge 10 and has a recess opening 111, a first inner side surface and a second inner side surface. The recess opening 111 is located at a bottom of the cartridge 10. With further reference to FIG. 6, preferably, the staple recess 11 has a rib 112 mounted on the second inner side surface of the staple recess 11.

The bracket 12 is longitudinally and slidably mounted in the staple recess 11 and is capable of closing the recess opening 111 of the staple recess 11.

The through hole 13 of the cartridge 10 is formed through the first inner side surface of the staple recess 11.

The taking opening 14 is formed through the first inner side surface and the second inner side surface of the staple recess 11, is adjacent to the recess opening 111 of the staple recess 11 and has a rectangular cross section.

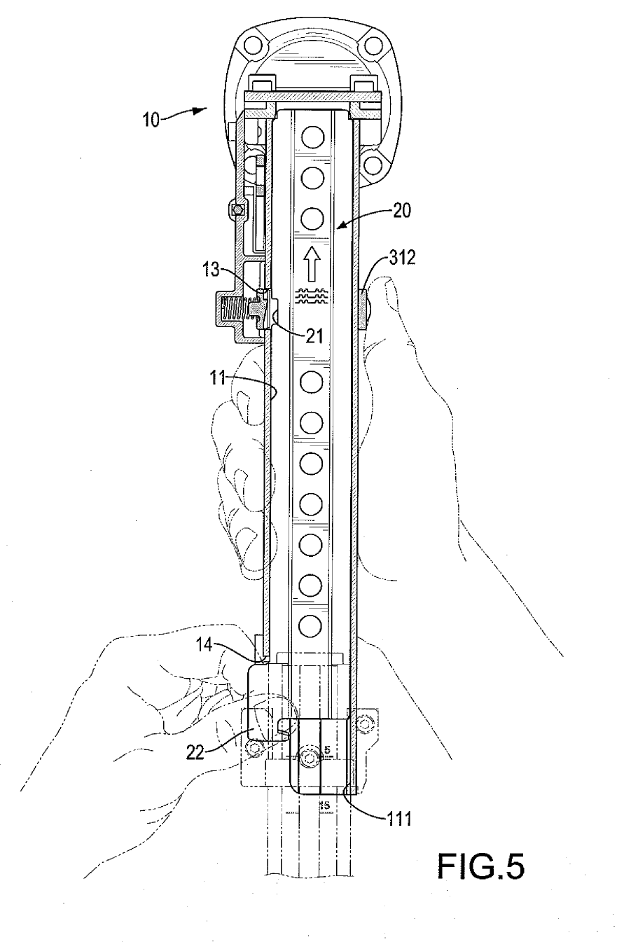

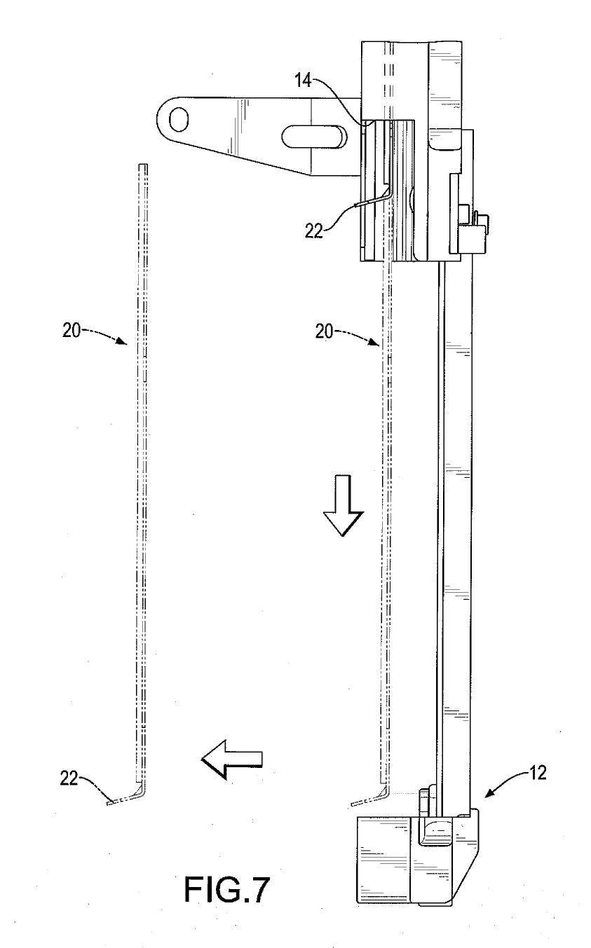

With reference to FIGS. 5 and 7, the adjusting strip 20 is an elongated metal strip, is slidably mounted in the staple recess 11 and has a positioning recess 21. The positioning recess 21 aligns with the through hole 13 of the cartridge 10 when the adjusting strip 20 is securely positioned in the staple recess 11 and has a rectangular cross section.

Preferably, a length of the adjusting strip 20 is shorter than that of the staple recess 11. The adjusting strip 20 has a tab 22 protruding from an outer surface of the adjusting strip 20, protruding out from the taking opening 14 and protruding relative to the cartridge 10.

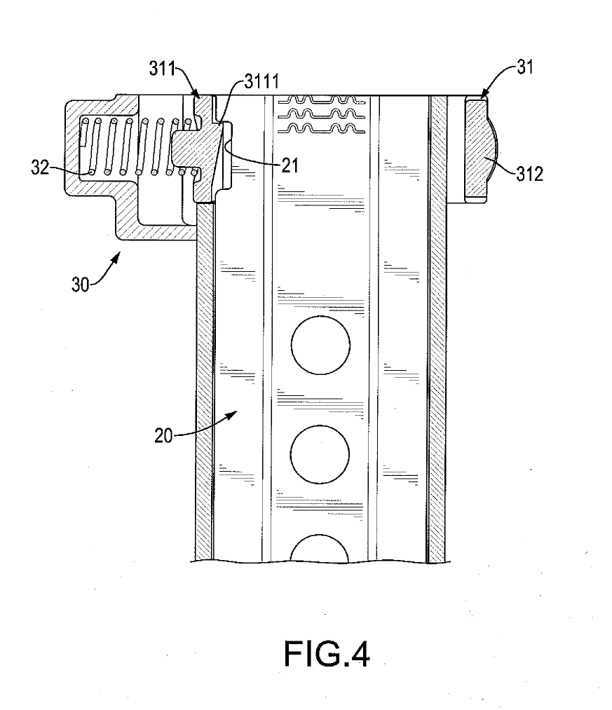

With reference to FIGS. 4 to 6, the positioning device 30 is mounted on the cartridge 10, engages the adjusting strip 20 to hold the adjusting strip 20 in place and has a positioning member 31 and an elastic member 32. The positioning member 31 is latitudinally and slidably mounted on the cartridge 10 and has a cross section, a first side, a second side, an abutted section 311 and a push section 312. The cross section of the positioning member 31 is substantially U-shaped. The second side of the positioning member 31 is opposite to the first side of the positioning member 31. The abutted section 311 is formed on the first side of the positioning member 31, is slidably mounted in the through hole 13 of the cartridge 10 and has a protrusion 3111. The protrusion 3111 is formed on the abutted section 311 and is mounted in and engages the positioning recess 21 and has a triangular cross section. The push section 312 is formed on the second side of the positioning member 31 and is located outside the cartridge 10.

Preferably, the positioning member 31 has a limit section 313 protruding from a surface of the positioning member 31, located between the first side of the positioning member 31 and the rib 112 and pressing against the rib 112.

The elastic member 32 is compressibly mounted in the cartridge 10 and presses the cartridge 10 and the first side of the abutted section 311. Preferably, the elastic member 32 is a spring. The elastic member 32 may be a bent metal sheet. The present invention does not limit the format of the elastic member 32.

The elastic member 32 is normally compressed and presses against the positioning member 31, so the limit section 313 normally presses against the rib 112. With the limit section 313 pressing against the rib 112, the positioning member 31 is positioned.

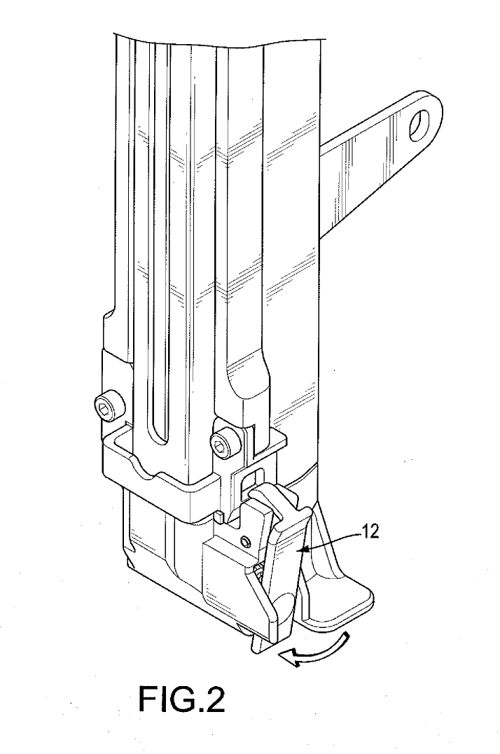

With reference to FIGS. 2 to 5, the bracket 12 is pulled downwardly in order to take out the adjusting strip 20 and then to adjust a position of the adjusting strip 20 in the staple recess 11. The push section 312 is pushed by a right hand of a user, the positioning member 31 is moved and the elastic member 32 is further compressed. Accordingly, the limit section 313 is detached from the rib 112 and the protrusion 3111 is disengaged from the positioning recess 21.

With reference to FIGS. 6 and 7, the tab 22 is held and pulled downwardly by a left hand of the user. With the tab 22, the adjusting strip 20 is easily held and pulled. Because the protrusion 3111 is disengaged from the positioning recess 21, the adjusting strip 20 can be pulled downwardly. Because the cartridge 10 has the taking opening 14, the adjusting strip 20 is easily taken out from the staple recess 11. Moreover, the adjusting strip 20 is easily taken out because the length of the adjusting strip 20 is shorter than that of the staple recess 11.

From the above description, it is noted that the present invention has the following advantages:

1. Easy Taking Out:

With the cartridge 10 having the taking opening 14, the adjusting strip 20 is easily taken out from the staple recess 11.

2. Secure Positioning:

The positioning device 30 can position the adjusting strip 20 securely and the adjusting strip 20 does not slide relative to the cartridge 10.

3. Easy Holding:

Because the tab 22 protrudes relative to the cartridge 10, the adjusting strip 20 is easily held and pulled.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A staple gun comprising:
a main body having a cartridge, a handle and a power device, the cartridge having
an elongated staple recess formed in the cartridge and having
a recess opening located at a bottom of the cartridge;
a first inner side surface; and
a second inner side surface next to the first inner side surface of the staple recess;
a bracket longitudinally and slidably mounted in the staple recess and capable of closing the recess opening of the staple recess;
a through hole formed through the first inner side surface of the staple recess; and
a taking opening formed through the first inner side surface and the second inner side surface of the staple recess and communicating with the recess opening of the staple recess;
an adjusting strip slidably mounted in the staple recess and having a positioning recess aligning with the through hole of the cartridge when the adjusting strip is securely positioned in the staple recess; and
a positioning device mounted on the cartridge, engaging the adjusting strip to hold the adjusting strip in place and having
a positioning member being U-shaped, latitudinally and slidably mounted on the cartridge and having
a first side;
a second side opposite to the first side of the positioning member;
an abutted section formed on the first side, slidably mounted in the through hole of the cartridge and having
a protrusion formed on the abutted section and mounted in and engaging the positioning recess; and
a push section formed on the second side and located outside the cartridge; and
an elastic member compressibly mounted between the cartridge and pressing against the cartridge and the first side of the positioning member.

2. The staple gun as claimed in claim 1, wherein the adjusting strip has a tab protruding from an outer surface of the adjusting strip, protruding out from the taking opening and protruding relative to the cartridge.

3. The staple gun as claimed in claim 2, wherein
the staple recess has a rib mounted on the second inner side surface of the staple recess; and
the positioning member has a limit section protruding from a surface of the positioning member, located between the first side of the positioning member and the rib and pressing against the rib.

4. The staple gun as claimed in claim 1, wherein a length of the adjusting strip is shorter than that of the staple recess.

5. The staple gun as claimed in claim 2, wherein a length of the adjusting strip is shorter than that of the staple recess.

6. The staple gun as claimed in claim 3, wherein a length of the adjusting strip is shorter than that of the staple recess.

7. The staple gun as claimed in claim 4, wherein the elastic member is a spring.

8. The staple gun as claimed in claim 5, wherein the elastic member is a spring.

9. The staple gun as claimed in claim 6, wherein the elastic member is a spring.
